(19) United States
(12) Patent Application Publication
(10) Pub. No.: US 2025/0118222 A1
(43) Pub. Date: Apr. 10, 2025

(54) DRIVER COACHING SYSTEM WITH MODULATION OF FEEDBACK BASED ON STAIRCASE METHOD

(71) Applicant: Toyota Research Institute, Inc., Los Altos, CA (US)

(72) Inventor: Hiroshi Yasuda, San Francisco, CA (US)

(73) Assignees: Toyota Research Institute, Inc., Los Altos, CA (US); Toyota Jidosha Kabushiki Kaisha, Toyota-shi (JP)

(21) Appl. No.: 18/481,621

(22) Filed: Oct. 5, 2023

(51) Int. Cl. G09B 19/16; G07C 5/02

(52) U.S. Cl. CPC G09B 19/167; G07C 5/02

(57) ABSTRACT

Systems and methods are provided systems and methods for driver training that modulate driver-training feedback on the fly based on a driver's ability to successfully perform vehicular maneuvers. In examples, sensor data is received from sensors on a vehicle. The sensor data is indicative of operation conditions of the vehicle executing a vehicular maneuver. An attribute of driver-training feedback can be adjusted based on a comparison of the operating conditions to a set of performance criteria associated with the vehicular maneuver that are representative of a successful execution of the vehicular maneuver.

### TECHNICAL FIELD

The present disclosure relates generally to driver training, and in particular, some implementations may relate to an adaptive dynamic driver trainer that modulates feedback based on executing vehicular maneuvers.

### DESCRIPTION OF RELATED ART

Race training approaches teach student drivers how to operate vehicles and perform vehicular maneuvers. For example, performance driving training courses teach student drivers to perform advanced vehicular maneuvers, such as high-speed navigation of a race course. The majority of race training is performed by a human instructor, who may be seated in the vehicle along with the student driver, to provide verbal instructions. Some of the interactions between an instructor and a student driver have been automated.

Automated race training is another racecar driver training modality in which data gathering and processing technologies are used to either augment or replace a human racing instructor. Some goals of automated race training may include 1) to ensure the safety of the student, especially as the car is operated closer and closer to its performance limits, and 2) to teach the student racing principles as effectively and efficiently as possible. A secondary, but still extremely important goal of training, is to deliver a user experience to the student that minimizes their frustration and improves their learning experience.

### BRIEF SUMMARY OF THE DISCLOSURE

According to various embodiments of the disclosed technology, systems and methods for managing vehicles to mitigate risk to the vehicles due to anomalous driving behavior are provided.

In accordance with some embodiments, a method for adaptive driver-training feedback is provided. The method comprises generating a command signal to cause a feedback circuit to apply driver-training feedback to a driver of a vehicle. The driver-training feedback is applied to induce successful performance of a maneuver. The method also comprises iteratively obtaining, from one or more sensors on a vehicle, sensor data corresponding to vehicle states of the vehicle during iterative performance of the maneuver. The maneuver comprises one or more performance criteria indicative of successful performance of the maneuver. For each iteration of performing the maneuver, the method comprises determining whether the maneuver was successfully performed by the vehicle based on the sensor data obtained during the iteration and the performance criteria and adjusting a level of an attribute of the driver-training feedback responsive to the determination.

In another aspect, a vehicle is provided that comprises a feedback circuit, one or more sensors, one or more processors communicably coupled to a memory. The one or more processors are configured to execute the instructions stored in the memory to generate a command signal to cause a feedback circuit to apply driver-training feedback to a driver of a vehicle. The driver-training feedback is applied to induce successful performance of a maneuver. The one or more processors are also configured to iteratively obtain, from one or more sensors on a vehicle, sensor data corresponding to vehicle states of the vehicle during iterative performance of the maneuver. The maneuver comprises one or more performance criteria indicative of successful performance of the maneuver. For each iteration of performing the maneuver, the. The one or more processors are configured to determine whether the maneuver was successfully performed by the vehicle based on the sensor data obtained during the iteration and the performance criteria and adjust a level of an attribute of the driver-training feedback responsive to the determination.

In another aspect, a driver training system is provided. The driver training system comprises a communication interface configured to receive sensor data from sensors on a vehicle. The sensor data is indicative of operation conditions of the vehicle executing a vehicular maneuver. The driver training system also comprises driver training circuit configured to adjust an attribute of driver-training feedback based on a comparison of the operating conditions to a set of performance criteria associated with the vehicular maneuver. The set of performance criteria are representative of a successful execution of the vehicular maneuver.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for adaptive driver training in accordance with one embodiment of the systems and methods described herein.

FIGS. 3A and 3B are graphical representations depicting examples of faded feedback during training sessions in accordance with embodiments of the disclosed technology.

FIGS. 4-6 are flow charts illustrating example operations for various adaptive driver training processes in accordance with embodiments disclosed herein.

FIG. 7 is an example computing component that may be used to implement various features of embodiments described in the present disclosure.

The figures are not exhaustive and do not limit the present disclosure to the precise form disclosed.

### DETAILED DESCRIPTION

As described above, automated race training is implemented to teach racing principles, including how to effectively and safely execute vehicular maneuvers, particularly advanced vehicular maneuvers, at high speed without assistance. Automated race training can be executed by providing assistance in the form of feedback presented to a student driver based on the performance of executing a maneuver. However, too much feedback can hinder skill retention because the student may become overly dependent on the feedback and, as a result, the student may be unable to execute the maneuver without assistance. Additionally, frequent application of feedback may overwhelm the student due to sensory overload, resulting in frustration and further hindrance to long-term skill retention. These hindrances, along with others, can result in a suboptimal user experience that can set back both skill retention and system adoption. At the same time, frequent assistance is known to be helpful for beginners who are just starting to learn a skill. Thus, a tradeoff exists between the amount of feedback provided and the skill level (or confidence) in executing a maneuver.

Accordingly, the technology disclosed herein provides systems and methods for driver training that modulate driver-training feedback on the fly based on a driver's ability to successfully perform vehicular maneuvers. The disclosed technology may be particularly well suited for race care training. Implementations disclosed herein can leverage faded feedback, which reduces an attribute level of driver-training feedback presented to a driver as the skill level of the driver increases. Driver-training feedback can comprise one or more of various types of feedback including, but not limited to, audible, visual, and haptic feedback that is presented or applied to the driver. Attributes of driver-training feedback can include, but are not limited to, frequency and intensity of the feedback. As an example, the technology disclosed herein can reduce the frequency and/or intensity level of driver-training feedback presented to the driver as the driver's ability to successfully execute a vehicular maneuver increases.

In an example implementation, the technology disclosed herein may provide real-time driver-training feedback to a driver while the driver is operating the vehicle while executing a vehicular maneuver. Real-time driver-training feedback can be provided to the driver to induce successful performance of the maneuver during a training session. For example, driver-training feedback may be supplied as haptic feedback in the form of a counter force exerted on the steering wheel that is adapted to induce the driver to turn the wheel in a direction that can ensure the successful performance of a vehicular maneuver. As another example, a counter force can exerted on a brake pedal and/or accelerator to induce the driver to operate the vehicle at a velocity that ensures successful performance of a vehicular maneuver. Successful performance of a vehicular maneuver can be defined by a set of performance criteria that, if met by the vehicle while executing the vehicular maneuver, are indicative of a successful execution of the vehicular maneuver. The implementations disclosed herein may receive sensor data from sensors on the vehicle while a driver is executing the vehicular maneuver and determine whether or not the vehicular maneuver was successfully performed by the vehicle based on the sensor data in view of the performance criteria. Responsive to the determination, implementations disclosed herein can adjust an attribute level of the driver-training feedback for a next instance of executing the vehicular maneuver. For example, responsive to a determination that the vehicular maneuver was successfully performed by the vehicle, the frequency and/or intensity of the driver-training feedback can be decreased. As another example, responsive to a determination that the vehicular maneuver was not successfully performed by the vehicle, the frequency and/or intensity of the driver-training feedback can be increased.

As an illustrative example, presume the vehicular maneuver to be performed is a drifting maneuver. A failed outcome would result in a spin-out, whereas a successful outcome would be an executed drift maneuver with no spin-out. Sensor data collected by sensors on the vehicle can be compared against performance criteria for the drifting maneuver to determine whether or not the outcome was successful or not. If the vehicle successfully performs the drifting maneuver, the implementations disclosed herein can reduce the level of an attribute of the driver-training feedback. In some examples, the level of the attribute may be continuously decreased with each successful execution. Conversely, responsive to a failed outcome, the level of the attribute can be increased. As such, the application of driver-training feedback can be dynamically adjusted to the level where the student has a good mix of success and failure.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

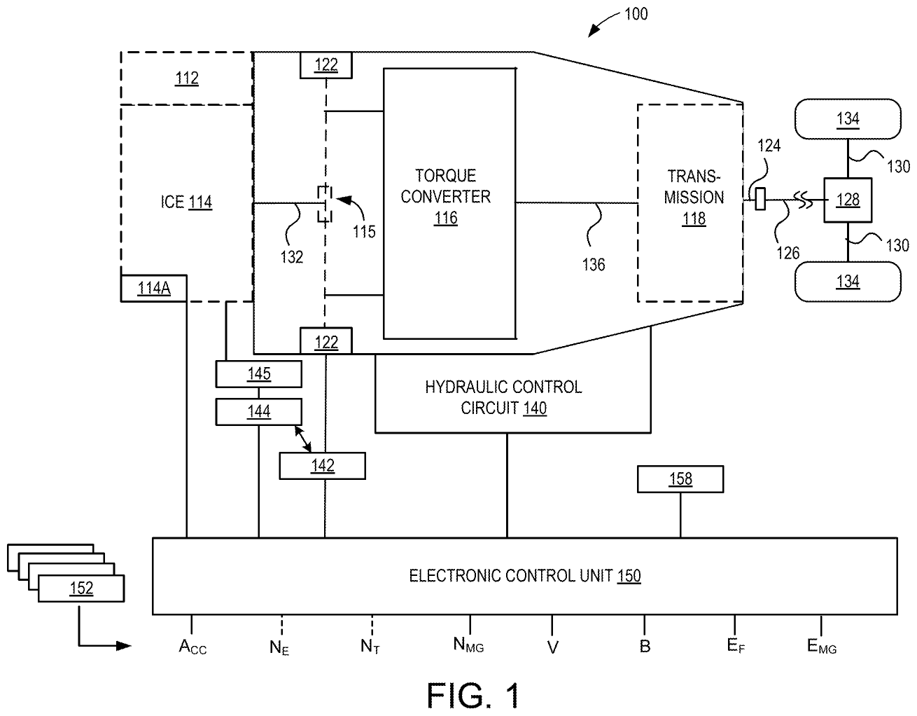

### FIG. 1

The systems and methods disclosed herein may be implemented with any of a number of different vehicles and vehicle types. For example, the systems and methods disclosed herein may be used with automobiles, trucks, motorcycles, race vehicles, recreational vehicles, and other like on- or off-road vehicles. In addition, the principles disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for adaptive driver training can be implemented in other types of vehicle including gasoline- or diesel-powered vehicles, fuel-cell vehicles, electric vehicles, or other vehicles.

FIG. 1 illustrates a drive system of an example vehicle 100 that may include an internal combustion engine 114 and one or more electric motors 122 (which may also serve as generators) as sources of motive power. Driving force generated by the internal combustion engine 114 and motors 122 can be transmitted to one or more wheels 134 via a torque converter 116, a transmission 118, a differential gear device 128, and a pair of axles 130.

As an HEV, vehicle 100 may be driven/powered with either or both of engine 114 and motor(s) 122 as the drive source for travel. For example, a first travel mode may be an engine-only travel mode that only uses internal combustion engine 114 as the source of motive power. A second travel mode may be an EV travel mode that only uses the motor(s) 122 as the source of motive power. A third travel mode may be an HEV travel mode that uses engine 114 and motor(s) 122 as the sources of motive power. In the engine-only and HEV travel modes, vehicle 100 relies on the motive force generated at least by internal combustion engine 114, and a clutch 115 may be included to engage engine 114. In the EV travel mode, vehicle 100 is powered by the motive force generated by motor 122 while engine 114 may be stopped and clutch 115 disengaged.

Engine 114 can be an internal combustion engine such as a gasoline, diesel, or similarly powered engine in which fuel is injected into and combusted in a combustion chamber. A cooling system 112 can be provided to cool the engine 114 such as, for example, by removing excess heat from engine 114. For example, cooling system 112 can be implemented to include a radiator, a water pump, and a series of cooling channels. In operation, the water pump circulates coolant through engine 114 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 114. In other applications, either or both the water pump and the fan may be operated by electric current such as from battery 144.

An output control circuit 114A may be provided to control the drive (output torque) of engine 114. Output control circuit 114A may include a throttle actuator to control an electronic throttle valve that controls fuel injection, an ignition device that controls ignition timing, and the like. Output control circuit 114A may execute output control of engine 114 according to a command control signal(s) supplied from an electronic control unit 150, described below. Such output control can include, for example, throttle control, fuel injection control, and ignition timing control.

Motor 122 can also be used to provide motive power in vehicle 100 and is powered electrically via a battery 144. Battery 144 may be implemented as one or more batteries or other power storage devices including, for example, lead-acid batteries, nickel-metal hydride batteries, lithium ion batteries, capacitive storage devices, and so on. Battery 144 may be charged by a battery charger 145 that receives energy from the internal combustion engine 114. For example, an alternator or generator may be coupled directly or indirectly to a drive shaft of internal combustion engine 114 to generate an electrical current as a result of the operation of internal combustion engine 114. A clutch can be included to engage/disengage the battery charger 145. Battery 144 may also be charged by motor 122 such as, for example, by regenerative braking or by coasting during which time motor 122 operates as a generator.

Motor 122 can be powered by battery 144 to generate a motive force to move the vehicle and adjust vehicle speed. Motor 122 can also function as a generator to generate electrical power such as, for example, when coasting or braking. Battery 144 may also be used to power other electrical or electronic systems in the vehicle. Motor 122 may be connected to battery 144 via an inverter 142. Battery 144 can include, for example, one or more batteries, capacitive storage units, or other storage reservoirs suitable for storing electrical energy that can be used to power motor 122. When battery 144 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 150 (described below) may be included and may control the electric drive components of the vehicle as well as other vehicle components. For example, electronic control unit 150 may control inverter 142, adjust the driving current supplied to motor 122, and adjust the current received from motor 122 during regenerative coasting and breaking. As a more particular example, the output torque of motor 122 can be increased or decreased by electronic control unit 150 through the inverter 142.

A torque converter 116 can be included to control the application of power from engine 114 and motor 122 to transmission 118. Torque converter 116 can include a viscous fluid coupling that transfers rotational power from the motive power source to the driveshaft via the transmission. Torque converter 116 can include a conventional torque converter or a lockup torque converter. In other embodiments, a mechanical clutch can be used in place of a torque converter 116.

Clutch 115 can be included to engage and disengage engine 114 from the drivetrain of the vehicle. In the illustrated example, a crankshaft 132, which is an output member of engine 114, may be selectively coupled to the motor 122 and torque converter 116 via clutch 115. Clutch 115 can be implemented as, for example, a multiple disc type hydraulic frictional engagement device whose engagement is controlled by an actuator such as a hydraulic actuator. Clutch 115 may be controlled such that its engagement state is complete engagement, slip engagement, and complete disengagement complete disengagement, depending on the pressure applied to the clutch. For example, a torque capacity of clutch 115 may be controlled according to the hydraulic pressure supplied from a hydraulic control circuit (not illustrated). When clutch 115 is engaged, power transmission is provided in the power transmission path between the crankshaft 132 and torque converter 116. On the other hand, when clutch 115 is disengaged, motive power from engine 114 is not delivered to the torque converter 116. In a slip engagement state, clutch 115 is engaged, and motive power is provided to torque converter 116 according to the torque capacity (transmission torque) of clutch 115.

As alluded to above, vehicle 100 may include an electronic control unit 150. Electronic control unit 150 may include circuitry to control various aspects of the vehicle operation. Electronic control unit 150 may include, for example, a microcomputer that includes a one or more processing units (e.g., microprocessors), memory storage (e.g., RAM, ROM, etc.), and I/O devices. The processing units of electronic control unit 150, execute instructions stored in memory to control one or more electrical systems or subsystems 158 in the vehicle. Electronic control unit 150 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 150 receives information from a plurality of sensors included in vehicle 100. For example, electronic control unit 150 may receive signals that indicate vehicle operating conditions or characteristics, or signals that can be used to derive vehicle operating conditions or characteristics. These may include, but are not limited to accelerator operation amount, (A_{CC}), a revolution speed (N_{E}), of internal combustion engine 114 (engine RPM), a rotational speed (N_{MG}) of the motor 122 (motor rotational speed), and vehicle speed (V). These may also include torque converter 116 output (N_{T}) (e.g., output amps indicative of motor output), brake operation amount/pressure (B), battery state of charge (SoC) (e.g., the charged amount for battery 144 detected by an SoC sensor). Accordingly, vehicle 100 can include a plurality of sensors 152 that can be used to detect various conditions internal or external to the vehicle and provide sensed conditions to electronic control unit 150 (which, again, may be implemented as one or a plurality of individual control circuits). In one embodiment, sensors 152 may be included to detect one or more conditions directly or indirectly such as, for example, fuel efficiency (E_{F}), motor efficiency (E_{MG}), hybrid (internal combustion engine 114+MG 122) efficiency, etc.

In some embodiments, one or more of the sensors 152 may include their own processing capability to compute the results for additional information that can be provided to the electronic control unit 150. In other embodiments, one or more sensors may be data-gathering-only sensors that provide only raw data to electronic control unit 150. In further embodiments, hybrid sensors may be included that provide a combination of raw data and processed data to electronic control unit 150. Sensors 152 may provide an analog output or a digital output.

Sensors 152 may be included to detect not only vehicle conditions but also to detect external conditions as well. Sensors that might be used to detect external conditions can include, for example, sonar, radar, lidar, or other vehicle proximity sensors, and cameras or other image sensors. Image sensors can be used to detect objects in an environment surrounding vehicle 100, for example, road curvature, obstacles, surrounding vehicles, and so on. Still, other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

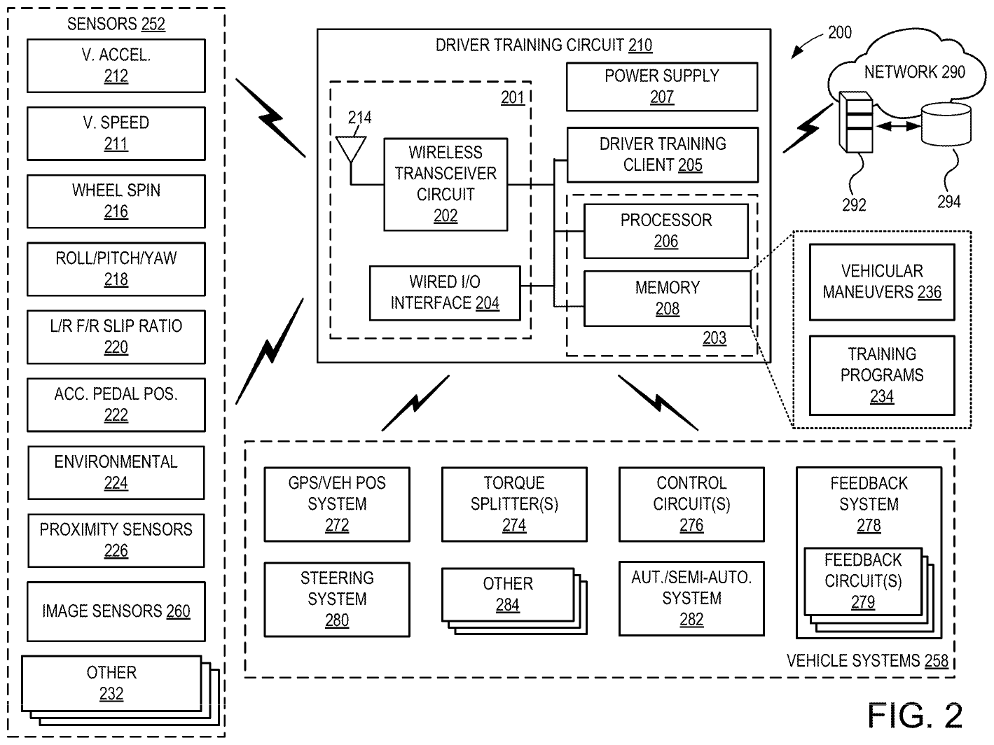

### FIG. 2

FIG. 2 illustrates an example architecture for driver training in accordance with one embodiment of the systems and methods described herein. Referring now to FIG. 2, in this example, the driver training system 200 includes a driver training circuit 210, a plurality of sensors 252, and a plurality of vehicle systems 258. Sensors 252 (such as sensors 152 described in connection with FIG. 1) and vehicle systems 258 (such as subsystems 158 described in connection with FIG. 1) can communicate with driver training circuit 210 via a wired or wireless communication interface. Although sensors 252 and vehicle systems 258 are depicted as communicating with driver training circuit 210, they can also communicate with each other as well as with other vehicle systems. driver training circuit 210 can be implemented as an ECU or as part of an ECU such as, for example, electronic control unit 150. In other embodiments, driver training circuit 210 can be implemented independently of the ECU.

Driver training circuit 210 in this example includes a communication circuit 201, a decision circuit 203 (including a processor 206 and memory 208 in this example), and a power supply 207. Components of driver training circuit 210 are illustrated as communicating with each other via a data bus, although other communication in interfaces can be included. Driver training circuit 210 in this example can also include driver training client 205 that can be operated to connect to cloud-based server 292 (including edge servers of a cloud network) hosted on network 290.

Processor 206 can include one or more GPUs, CPUs, microprocessors, or any other suitable processing system. Processor 206 may include a single core or multicore processors. Memory 208 may include one or more various forms of memory or data storage (e.g., flash, RAM, etc.) that may be used to store instructions and variables for processor 206 as well as any other suitable information, such as one or more of the following elements: vehicular maneuver information 236 including vehicular maneuvers and associated performance criteria, driver training program information 234 defining driver-training feedback to be provided to a driver during training sessions, along with other data as needed. Memory 208 can be made up of one or more modules of one or more different types of memory, and may be configured to store data and other information as well as operational instructions that may be used by the processor 206 to driver training circuit 210.

Although the example of FIG. 2 is illustrated using processor and memory circuitry, as described below with reference to circuits disclosed herein, the decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines, or other mechanisms might be implemented to make up a driver training circuit 210.

Communication circuit 201 includes either or both a wireless transceiver circuit 202 with an associated antenna 214 and a wired I/O interface 204 with an associated hardwired data port (not illustrated). Communication circuit 201 can provide for vehicle-to-everything (V2X) and/or vehicle-to-vehicle (V2V) communications capabilities, allowing driver training circuit 210 to communicate with edge devices, such as roadside unit/equipment (RSU/RSE), network cloud servers, and cloud-based databases, and/or other vehicles via network 290. For example, V2X communication capabilities allow driver training circuit 210 to communicate with edge/cloud servers 292. Edge/cloud servers 292 may be connected to cloud-based databases 294 resident on network 290.

As this example illustrates, communications with driver training circuit 210 can include either or both wired and wireless communications circuits 201. Wireless transceiver circuit 202 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by the wireless transceiver circuit 202 to transmit radio signals wirelessly to wireless equipment with which it is connected and to receive radio signals as well. These RF signals can include information of almost any sort that is sent or received by driver training circuit 210 to/from other entities such as sensors 252 and vehicle systems 258.

Wired I/O interface 204 can include a transmitter and a receiver (not shown) for hardwired communications with other devices. For example, wired I/O interface 204 can provide a hardwired interface to other components, including sensors 252 and vehicle systems 258. Wired I/O interface 204 can communicate with other devices using Ethernet or any of a number of other wired communication protocols whether standardized, proprietary, open, point-to-point, networked, or otherwise.

Power supply 207 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 252 can include, for example, sensors 152 such as those described above with reference to the example of FIG. 1. Sensors 252 can include additional sensors that may or may not otherwise be included on a standard vehicle with which the driver training system 200 is implemented. In the illustrated example, sensors 252 include vehicle acceleration sensors 212, vehicle speed sensors 211, wheelspin sensors 216 (e.g., one for each wheel), accelerometers such as a 2- or 3-axis accelerometers 218 to detect roll, pitch, and yaw of the vehicle, left-right and front-rear slip ratio sensors 220, throttle engagement sensors (i.e., accelerator pedal position) 222; environmental sensors 224 (e.g., to detect salinity or other environmental conditions); and proximity sensor 226 (e.g., sonar, radar, lidar or other vehicle proximity sensors).

Additional sensors 232 can also be included as may be appropriate for a given implementation of driver training system 200. For example, additional sensors 232 may include sensors for brake engagement, clutch engagement, and steering wheel position. Sensors 232 may also include a timer or clock for measuring a window of time, such as the amount of time to complete a lap of a track (e.g., lap time). There may also be additional sensors for detecting and/or computing sideslip velocities, sideslip angles, percent sideslip, frictional forces, degree of steer, heading, trajectory, front slip angle corresponding to full tire saturation, rear slip angle corresponding to full tire saturation, maximum stable steering angle given speed/friction, gravitational constant, coefficient of friction between vehicle tires and roadway, distance from center of gravity of the vehicle to front axle, distance from center of gravity of vehicle to rear axle, total mass of the vehicle, total longitudinal force, rear longitudinal force, front longitudinal force, total lateral force, rear lateral force, front lateral force, longitudinal speed, lateral speed, longitudinal acceleration, time derivatives of steering wheel position, time derivatives of throttle, gear, exhaust, revolutions per minutes, mileage, emissions, and/or other operational parameters (also referred to herein as states) of the vehicle.

System 200 may be equipped with one or more image sensors 260. These may include front facing image sensors, side facing image sensors, and/or rear facing image sensors. Image sensors may capture information that may be used in detecting not only vehicle conditions but also detecting conditions external to the vehicle as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc. Image sensors 260 can be used to, for example, to detect objects in an environment surrounding a vehicle comprising driver training system 200. Additionally, sensors may estimate proximity between vehicles. For instance, the image sensors 260 may include cameras that may be used with and/or integrated with other proximity sensors 232 such as LIDAR sensors or any other sensors capable of capturing a distance.

Vehicle systems 258, for example, systems and subsystems 158 described above with reference to the example of FIG. 1, can include any of a number of different vehicle components or subsystems used to control or monitor various aspects of the vehicle and its performance. In this example, the vehicle systems 258 includes a GPS or other vehicle positioning system 272; torque splitters 274 that can control distribution of power among the vehicle wheels such as, for example, by controlling front/rear and left/right torque split; engine/motor control circuits 276 to control the operation of engine or motor (e.g. motor 122 or internal combustion engine 114); feedback system 278 to provide feedback to the driver via feedback circuits 279; steering system 280 (which may be, for example, the steering by-wire system described in conjunction with FIG. 1) to turn the wheels of vehicle 100; autonomous or semi-autonomous driving systems 282 (e.g., Advanced Driver-Assistance Systems (ADAS), such as forward/rear collision detection and warning systems, pedestrian detection systems, autonomous or semi-autonomous driving systems for automated or semi-automated control of the vehicle and vehicle subsystems 258, and the like); and other vehicle systems 284 as may be useful for the driver training system 200.

Autonomous or semi-autonomous driving systems 282 can be operatively connected to the various vehicle systems 258 and/or individual components thereof. For example, autonomous or semi-autonomous driving systems 282 can send and/or receive information from the various vehicle systems 258 to control the movement, speed, maneuvering, heading, direction, etc. of the vehicle. The autonomous or semi-autonomous driving systems 282 may control some or all of these vehicle systems 258 and, thus, may be semi- or fully autonomous.

Feedback system 278 may comprise and/or be operatively connected to one or more feedback circuits for implementing driver-training feedback by controlling the feedback circuits 279. For example, feedback system 278 can send feedback control signals to one or more feedback circuits for generating driver-training feedback that is presented to a driver through the feedback circuits 279. The feedback system 278 may be operatively connected to driver training circuit 210, which can be configured to execute a training program and issue commands for triggering feedback system 278 to generate the feedback control signals that are used to control the feedback circuits.

Feedback circuit(s) 279 may include, but are not limited to, speakers disposed within a cabin of the vehicle 100; displays (e.g., liquid crystal displays or LCDs, touch screen displays, traditional displays and the like) disposed within a vehicle 100, such as but not limited to, heads up displays of the vehicle 100, instrument panel, any other display provided in the vehicle, lights disposed within the cabin of the vehicle 100 (e.g., light emitting diodes or LEDs that can change color according to feedback), haptic feedback generators, such as but not limited to, eccentric rotating mass actuators, piezoelectric actuators, force feedback devices (e.g., servo motors) that use motors to manipulate movement of an item (e.g., a steering wheel, accelerator pedal, brake pedal, etc.).

Feedback circuit(s) 279 can be implemented to provide driver-training feedback to the driver. For example, audible feedback can be provided to the driver during a training session such as verbal instructions to the driver on how to negotiate the course or on how to improve his speed through the course. Verbal instructions may be generated by a recording of the instructions created in advance and stored in training program information 234, real-time instructions through a communication link with a coach, or an artificial intelligence that generates instructions which is provided through text-to-speech techniques. As another example, audible feedback may be provided as tone(s) to the driver to remind the driver of certain actions to take. Real-time visual feedback can also be provided such as, for example, through a head unit display, a heads-up display, displays on side or rear-view mirrors, one or more light sources provided throughout a cabin, etc. The visual feedback may be provided as a video of visual instructions on how to operate the vehicle to execute the maneuver (e.g., a video depicting in which direction and how much to turn a steering wheel, operate the accelerator or brake pedal, shift gears, etc.). Visual feedback may also be provided as pulses of light indicating a direction of controlling the vehicle, colored lights indicating good (green) or poor (red) execution, etc. Real-time feedback can also be provided as haptic feedback that is physically communicated to the driver. The haptics can be controlled to induce certain actions by the driver. For example, counter forces can be applied to the steering wheel and/or accelerator/brake pedals. The counter force may be used to induce the driver to perform less of the action or in a different direction (e.g., turn the steering wheel less or release the accelerator pedal). Other haptic feedback can be used, such as, but not limited to, vibrational feedback that is imparted to the driver to induce action. For example, vibrating the steering wheel to remind the driver to operate the steering wheel, vibrating a pedal to cause the driver to interact with the vibrating pedal, etc. Real-time feedback can be provided immediately or almost immediately (i.e., subject only to system latencies) to provide real-time audio, visual, or haptic feedback to the driver. The feedback can also be timed to be delivered at the appropriate time and location on the track or maneuver where it is most relevant or useful.

Network 290 may be a conventional type of network, wired or wireless, and may have numerous different configurations including a star configuration, token ring configuration, or other configurations. Furthermore, network 290 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 290 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 7G, LTE, LTE-V2V, LTE-V2I, LTE-V2X, LTE-D2D, VOLTE, 7G-V2X or any other mobile data network or combination of mobile data networks. Further, network 290 may include one or more IEEE 802.11 wireless networks.

In some embodiments, network 290 includes a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 7G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term Evolution (LTE); millimeter wave (mmWave) communication; 3G; 4G; 7G; LTE-V2X; 7G-V2X; LTE-Vehicle-to-Vehicle (LTE-V2V); LTE-Device-to-Device (LTE-D2D); Voice over LTE (VOLTE); etc. In some examples, the V2X communications can include V2V communications, Vehicle-to-Infrastructure (V2I) communications, Vehicle-to-Network (V2N) communications or any combination thereof.

Examples of a wireless message (e.g., a V2X wireless message) described herein include, but are not limited to, the following messages: a Dedicated Short Range Communication (DSRC) message; a Basic Safety Message (BSM); a Long-Term Evolution (LTE) message; an LTE-V2X message (e.g., an LTE-Vehicle-to-Vehicle (LTE-V2V) message, an LTE-Vehicle-to-Infrastructure (LTE-V2I) message, an LTE-V2N message, etc.); a 7G-V2X message; and a millimeter wave message, etc.

As noted above, driver training system 200 includes training program information 234 and vehicular maneuver information 236. The training program information 234 and vehicular maneuver information 236 may be stored in memory 208 and/or stored in cloud-based database 294 and accessed by driver training client 205 via network 290. The training program information 234 and vehicular maneuver information 236 may comprise a data structure for referencing information.

Training program information 234 may include one or more driver training modules and the different modules may be characterized as training modules for different vehicular maneuvers. For example, training program information 234 can comprise technique training modules for training specific driving techniques. Examples of technique training modules can include, but not limited to, drifting maneuvers, corner entry maneuvers, corner apex approach maneuvers, corner exit maneuvers, trail braking, heel-toe downshifting, negotiating sacrifice corners, maximizing the friction circle, and so on. Training program information 234 can also comprise track training modules for training track-specific techniques. Examples of track training modules can include, but are not limited to, minimizing lap time for defined tracks, maintaining an optimal line for defined tracks, including corner turn-in, apex approach, and corner exit for a track-specific race line, and so on. The different modules may include, for example, feedback parameters for each vehicular maneuver that define when during a vehicular maneuver to generate feedback for application to a driver. The feedback parameters may also define a type of feedback to be applied, which may be one or more feedback types (e.g., haptic, audio, visual, etc.), as well as a level of intensity of the feedback.

As an illustrative example, a technique training module may be provided for training a drifting maneuver. Feedback parameters may define a timing when feedback is to be provided while a drifting maneuver is performed and the type of feedback. An example of a feedback timing parameter may be when the driver needs to apply counter steering to maintain the drifting maneuver. Feedback type parameters may define whether the feedback is to provide by changing a color of a visual indicator (e.g., LEDs disposed in the cabin of the vehicle to red), emitting a sounds from speakers (e.g., playing beep sound), haptic feedback (e.g., applying directional vibration on the handwheel), etc. For example, based on sensors 252 and/or vehicle systems 258 driver training circuit 210 may detect that the rear end of vehicle 100 is starting to come around detecting a potential spin out. This condition may satisfy the feedback timing parameter, which triggers driver training circuit 210 to send a control signal to feedback system 278 to generate feedback to induce a counter steer that beings the vehicle balance. The control signal may also include feedback type parameters that indicates which feedback circuit 279 feedback system 278 is to use to generate feedback.

Vehicular maneuver information 236 may include one or more vehicular maneuvers and associated performance criteria indicative of successfully executing one or more vehicular maneuvers. Each vehicular maneuver can associated with a set of performance criteria that define a successful execution of the vehicular maneuver. Successful execution may be considered as a binary determination of either successful or not. Additionally, the performance criteria may define conditions or states of the vehicle that correspond to initiating a maneuver, which may be used to detect whether or not a vehicular maneuver is being initiated by the vehicle. The vehicular maneuvers included in vehicular maneuver information 236 may include one or more of those in the training program information 234.

During operation, driver training circuit 210 can be implemented to provide driver-training feedback. Driver training circuit 210 can receive information from various vehicle sensors 252 and/or vehicle systems 258 via communication circuit 201. The sensor data can be used to determine vehicle states or conditions of operation. In some examples, the vehicle states may be compared to performance criteria in vehicular maneuver information 236 to identify a vehicular maneuver from those listed included vehicular maneuver information 236. Based on the identification, driver training circuit 210 can detect that the vehicle has initiated to execution of the identified vehicular maneuver.

For example, a side slip angle may be used to determine if a drifting maneuver has been initiated by the vehicle. Side slip angle refers to an angle between a direction of travel (e.g., a heading direction) and the direction that the body of the vehicle is pointing (e.g., a longitudinal direction of the vehicle). Vehicular maneuver information 236 may include a side slip angle threshold. A side slip angle below this threshold (e.g., an example of performance criteria) is indicative of no drifting maneuver and a side slip angle at or above the threshold is indicative that the vehicle initiated a drifting maneuver. Driver training circuit 210 may receive data from sensors 252 and/or vehicle systems 258 (e.g., heading direction from other vehicle positioning system 272, orientation of the vehicle from accelerometers 218, and the like). Driver training circuit 210 uses to determine a current side slip angle, which is an example vehicle state or condition of operation. Driver training circuit 210 can track the side slip angle over time and, when the side slip angle passes the side slip angle threshold driver training circuit 210 detects that a drifting maneuver has been initiated. The exact value of the side slip angle threshold is dependent on various factors, such as type of vehicle, road conditions, tires, etc.

In implementation, while executing a vehicular maneuver, driver training circuit 210 can be implemented to trigger feedback system 278 to generate feedback according to training program information 234. For example, driver training circuit 210 can be configured to retrieve feedback parameters for vehicular maneuver being performed by the vehicle and transmit commands to feedback system 278, which feedback system 278 uses to send feedback control signals to feedback circuits. Communication circuit 201 can be used for the transmission and reception of signals. The command from driver training circuit 210 may identify one or more feedback circuits for generating feedback, a type of feedback, and an intensity of feedback to be generated. The feedback system 278 may receive these parameters and control the identified feedback circuits according to the control signals. The training program information 234 can define the feedback circuits, type, and intensity to induce the successful execution of the corresponding vehicular maneuver. In some implementations, driver training circuit 210 may detect the execution of a vehicular maneuver and retrieve feedback parameters for the detected vehicular maneuver from training program information 234.

With reference to the above example, driver training circuit 210 may retrieve training program information 234 for a drifting maneuver. In some examples, the training program information 234 may be retrieved responsive to detecting an initiated maneuver. In other examples, training program information 234 may already be accessed by 210, for example, during a defined training session. Training program information 234 may include feedback parameters for a drifting maneuver, such as feedback timing parameters corresponding feedback type parameters. In one example, a feedback timing parameter may be a feedback trigger threshold that, in this example, is representative of an maximum side slip angle before the rear end of the vehicle is to come around causing a spin out. Driver training circuit 210 may monitor the side slip angles during execution of the vehicle based on sensor data, as described above. If the side slip angle of the vehicle is at or exceeds the feedback trigger threshold, driver training circuit 210 transmits commands to feedback system 278 to cause feedback to induce a counter steer. The command may include the feedback type parameter associated with the feedback timing parameter. The feedback type parameter may include identification of a feedback type (e.g., feedback circuits 279 for generating feedback), an intensity of the feedback, and a frequency of the feedback. Feedback system 278 can then transmit a control signal to selected feedback circuits 279 so to generate the indicated feedback.

In implementations, driver training circuit 210 may receive sensor data while the vehicle is executing a vehicular maneuver and determine whether or not the vehicular maneuver was successfully performed based on the sensor data in view of the performance criteria contained in vehicular maneuver information 236. For example, the sensor data may define vehicle states and/or operating conditions. Driver training circuit 210 can compare the vehicle states and/or operating conditions to performance criteria that define the successful execution of the vehicular maneuver and determine whether or not the vehicular maneuver was performed successfully. Based on the determination, driver training circuit 210 can adjust an attribute level of the driver-training feedback in the training program information 234 for a next instance of executing the vehicular maneuver. For example, responsive to a determination that the vehicular maneuver was successfully performed, driver training circuit 210 may reduce the frequency and/or intensity of the driver-training feedback. As another example, responsive to a determination that the vehicular maneuver was not successfully performed, driver training circuit 210 may increase the frequency and/or intensity of the driver-training feedback.

As an illustrative example, the vehicular maneuver being performed is a drifting maneuver. In this case, the performance criteria may define a failed outcome as a spin-out and a successful outcome as an executed drift maneuver with no spin-out. Driver training circuit 210 may determine a state of the vehicle during or following the completion of the vehicular maneuver and compare the state of the vehicle to the performance criteria. If the state of the vehicle indicates that a spin-out did not occur and the drifting maneuver was performed, driver training circuit 210 may determine that a successful drifting maneuver was executed and may reduce the level of an attribute of the driver-training feedback. Conversely, responsive to a failed outcome, driver training circuit 210 may increase the level of the attribute. In either case, the adjusted attribute can be stored in training program information 234 as a feedback parameter for the vehicular maneuver. During a next instances of executing the drifting maneuver, the adjusted attribute can be communicated to the feedback system 278 along with other feedback parameters for generating feedback according to training program information 234. As such, driver training circuit 210 can dynamically adjust to the driver-training feedback.

While the above description is made with reference to driver training circuit 210 and the various functionalities and information carried by a vehicle, the implementations disclosed herein are not intended to be limited to local execution. Instead, certain functionality may be offloaded to cloud servers 292 and cloud-based databases 294 and communicated to driver training circuit 210 through driver training client 205 over network 290. For example, vehicular maneuver information 236 and/or training program information 234 may be stored in a cloud-based database 294 and accessed via driver training client 205. As another example, certain functionality executed by driver training circuit 210, such as, but not limited to, determining the success or failure of an execution, may be performed by cloud servers 292. In this case, for example, driver training circuit 210 may determine vehicle states using sensor data from sensors 252 and transmitted to cloud servers 292, and/or raw sensor data may be communicated to cloud servers 292 for determining vehicle states. In either case, the vehicle states may be used by cloud servers 292 in the manner described above to adjust an attribute of the driver-training feedback, which can be communicated to driver training circuit 210 for application during a next instance of the vehicular maneuver.

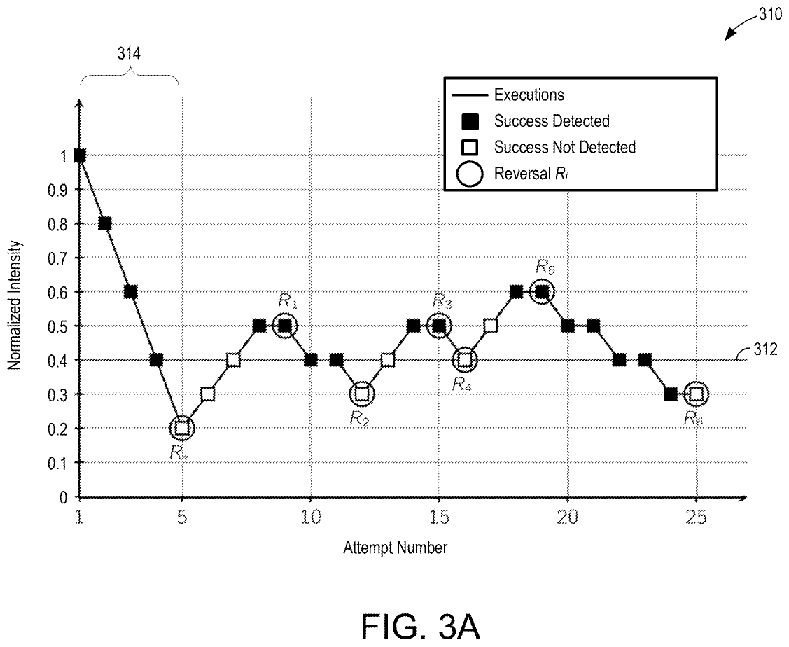

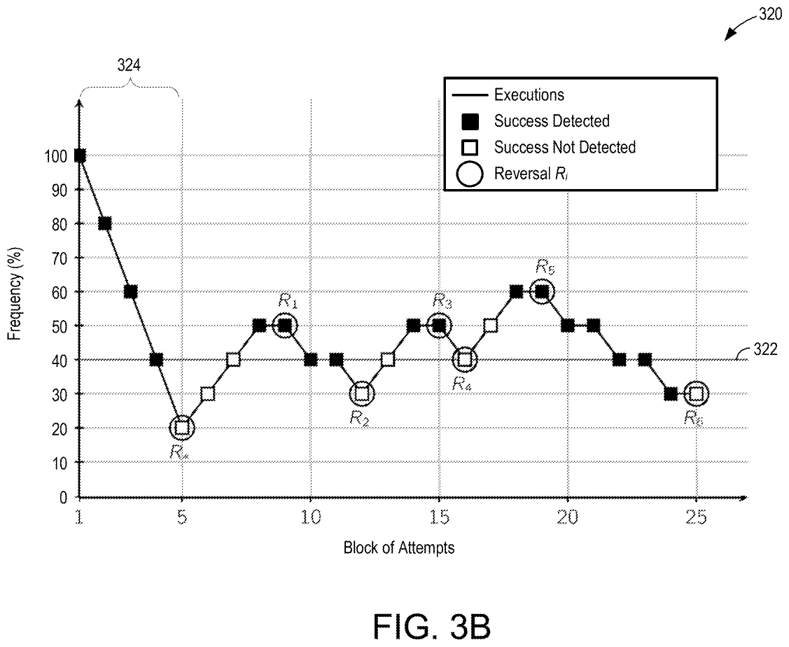

### FIGS. 3A and 3B

FIGS. 3A and 3B are graphical representations depicting examples of faded feedback during training sessions in accordance with implementations of the disclosed technology. FIG. 3A shows faded feedback in terms of adjusting the intensity level of driver-training feedback and FIG. 3B shows faded feedback in terms of adjusting the frequency level of driver-training feedback. FIGS. 3A and 3B may each represent a training session.

Referring to FIG. 3A, an adjusted intensity level 310 is plotted as normalized intensity as a function of number of attempted executions of a vehicular maneuver. Black boxes represent detections of successful executions and white boxes represent that a successful execution was not detected (e.g., failure or unsuccessful). Success and unsuccessful may be detected as described above using sensor data to determine vehicle states or operating conditions, comparing the vehicle states or operating conditions to performance criteria, and detecting a successful execution where the vehicle states or operating conditions match the performance criteria or unsuccessful execution where a match is not found.

FIG. 3A illustrates an example where the adjusted intensity level 310 is changed using a staircase method (also referred to as an up-down method). As shown in FIG. 3A, as successful executions are detected, the normalized intensity of the driver-training feedback can be incremented down. For example, the driver-training feedback can be reduced to lower intensity levels. Once an unsuccessful execution is detected a reversal in adjustment level is triggered and the intensity level is incremented up or increased to a higher intensity level. The intensity level can be increased incrementally for each unsuccessful execution until a successful execution is detected.

The reversals, corresponding to successful and unsuccessful executions, may oscillate about a trend line 312. The trend line 312 may represent the skill level of the driver. While FIG. 3A illustrates a consistent trend line 312, in various implementations the trend line 312 may slope down toward lower intensity levels as the training progresses. This is because as training progresses the student driver should become more proficient in performing the vehicular maneuver and thus perform the maneuver successfully more frequently. As such, the instances of unsuccessful maneuvers should decrease and the reversals upward (e.g., increase intensity) occur less frequently leading to an overall downward trend.

FIG. 3A also depicts a startup phase 314 of the training. During the startup phase, the driver's skill level may be unknown. As a result, the intensity of the driver-training feedback may be set at a maximum level and incrementally decreased until a first unsuccessful execution is detected. The startup phase 314 functions to converge an initial (or baseline) skill level of the student at the start of the training session. As a result, the implementations disclosed herein need not know a skill level and can be personalized to each driver, independent of a skill level at the outset.

In the illustrative example shown in FIG. 3A, the staircase method utilizes a one-up, two-down rule. For example, upon detecting an unsuccessful execution, the intensity level is incremented up or increased. Whereas, the intensity level is incremented down or decreased after detecting two sequential successful executions. In this case, upon detecting a first successful execution the upward incrementing is stopped, and a reversal in incrementing trajectory (e.g., increment down or decrease) is triggered upon detecting a second successful execution. Note that in the example of FIG. 3A, the one-up, two-down rule may not be implemented during the startup phase 314 to quickly converge on the baseline skill level of the driver, which can decrease the overall time required to complete a training session.

While FIG. 3A illustrates the one-up, two-down rule as an example, other rules may be implemented as desired. For example, implementations disclosed herein may utilize a one-up, one-down rule. As another example, implementations disclosed herein may utilize n-up, m-down rule, where n and m integers that may be the same or different. In this case, n may be greater than, less than, or equal to m.

FIG. 3B is similar to FIG. 3A except that FIG. 3B depicts an adjusted frequency level 320 plotted as the frequency of providing driver-training feedback as a function of a blocks of attempted executions of a vehicular maneuver. Frequency as used herein refers to a rate at which driver-training feedback is applied to the driver as a function of performing a vehicular maneuver. That is, for example, the frequency of driver-training feedback may represent a number of instances of performing a vehicular maneuver between instances of applying driver-training feedback. A block of attempted executions refers to a number N of attempts or perform a vehicular maneuver, where N is a number of sequential attempts grouped into a given block. In this case, a frequency of 100% may represent applying driver-training feedback for each instance of attempting to perform a vehicular maneuver of a given block, while a frequency of 50% means that driver-training feedback is applied half of the time for a given block of attempts. The instances for which driver-training feedback is applied for a given block may be a random instance selected according to the percentage for that block. For example, N may be 10 attempts (other numbers may be used) and 50% refers to applying driver-training feedback for five of the 10 attempts. Which five attempts for which driver-training feedback is applied can be selected randomly.

The methodology of the adjustment in frequency in FIG. 3B can proceed similarly to FIG. 3A above. That is, adjusted frequency level 320 can be changed using a staircase method where the frequency is incremented up or down depending on detecting successful or unsuccessful attempts. FIG. 3B also illustrates a one-up, two-down rule for the staircase method and a startup phase 324, both of which may be similar to those described above in connection with FIG. 3A. Further, FIG. 3B illustrates a trend line 322, which may slope downward as training progresses and driver skill increases, as described above. In the case of FIG. 3B, an unsuccessful attempt may refer to detecting one or more unsuccessful attempts within a given block of attempts. Thus, in some cases, a single unsuccessful attempt in one block of attempts may cause a reversal of the direction for which the frequency is incremented. Whereas, in some cases, a successful detection may occur where all N instances of attempts are successful.

FIGS. 3A and 3B depict example attributes in the form of intensity and frequency. However, driver-training feedback may have additional attributes, such as feedback type. In this case, implementations disclosed herein may adjust the feedback type and/or number of types according to whether an executed maneuver is successful or not. For example, at a maximum level, the driver-training feedback may be supplied as visual feedback, but upon detecting an unsuccessful maneuver the driver-training feedback may be adjusted to use haptic feedback. Upon detecting a sequentially next unsuccessful maneuver, the driver-training feedback may be adjusted to use audio feedback. Similarly, the format of each type of feedback (e.g., detailed explanation vs. sound pulses) may be adjusted. For example, the detail in the feedback may be increased as failures occur. In another example, the number of types of driver-training feedback may be increased responsive to unsuccessful maneuvers or decreased responsive to successful maneuvers. For example, one type of feedback may be used at first (e.g., visual feedback) but, upon detecting an unsuccessful maneuver, an additional type of feedback is added (e.g., haptic feedback is added to the visual feedback).

Further still, a scale of adjustment of the feedback may be adjusted based on whether a maneuver is successful or not. For example, the rate at which the attribute of the driver-training feedback is increased or decreased may be altered based on whether a maneuver has successfully been performed. As an illustrative example, before any successful completion of a maneuver, the rate that an attribute level is increased in each iteration may be a first rate (e.g., a 10% change in the attribute level). After the driver has completed the task, the rate at which the attribute level decreases may be reduced (e.g., a 5% change in attribute level).

The various methods of adjusting attribute levels disclosed herein need to be exclusive. That is, implementations disclosed herein may combine any of the above methods with other methods to provide a training program that is customizable to the driver and designed to increase the driver's retention of skills during training sessions. Certain drivers may respond to different methods better than others, thus the implementations disclosed herein can be adapted to provide optimal skill retention while ensuring driver-training feedback is provided to the drivers to facilitate this retention.

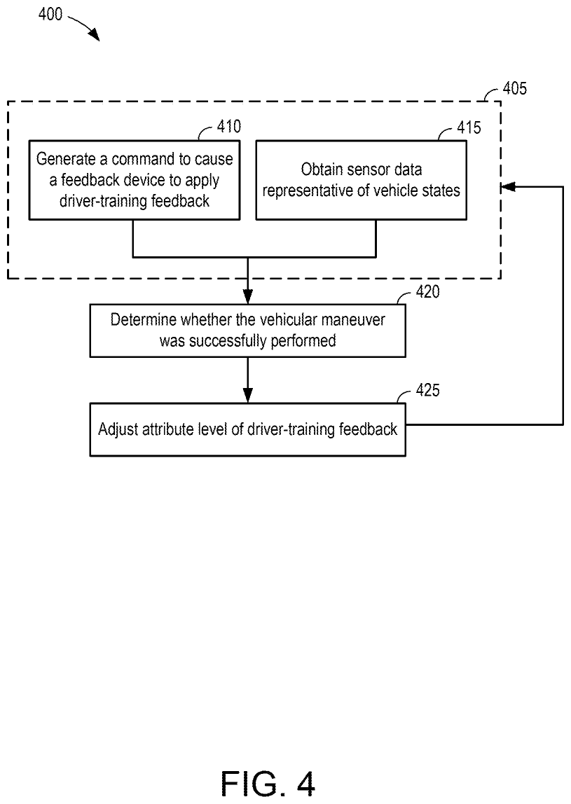

### FIG. 4-6

FIG. 4 is a flow chart illustrating example operations for adaptive driver training process 400 in accordance with embodiments disclosed herein. Process 400 may be implemented as instructions, for example, stored on driver training circuit 210, that when executed by one or more processors perform one or more operations of process 400. In another example, process 400 may be implemented as instructions stored on cloud server 292 that, when executed by one or more processors, performs one or more operations of process 400.

Process 400 includes, while a vehicle is executing a vehicular maneuver at operation 405, generating a command signal to cause a feedback circuit to apply driver-training feedback to a driver at operation 410. In some examples, operation 410 can be performed by driver training circuit 210, which generates the command signal and transmits the command signal to feedback system 278 according to training program information 234. Feedback system 278 then generates a control signal that is provided to one or more feedback circuits based on commands from driver training circuit 210. The driver-training feedback may be generated and applied to a driver to induce certain actions by the driver for successfully performing the vehicular maneuver. The driver-training feedback may be applied to the driver through any feedback, such as, but not limited to, audio, visual, haptic, and the like. As described above, the driver-training feedback may comprise one or more attributes, such as the intensity and/or frequency at which the driver-training feedback is generated and applied to the driver.

At operation 415, while operation 405 is being performed, sensor data is obtained that represents vehicle states and/or operating conditions of the vehicle while executing the maneuver. Sensor data may be obtained, for example, by driver training circuit 210 from sensors 252 and/or vehicle systems 258 as described above. Sensor data may be obtained as time series data from which states of the vehicle can be determined by driver training circuit 210. The sensor data and/or states (or operating conditions) can be stored, for example, in memory 208.

At operation 420, a determination is made as to whether or not the vehicular maneuver was successfully performed. For example, driver training circuit 210 may compare the vehicle states and/or operating conditions determined at operation 415 and compare the states to performance criteria associated with the vehicular maneuver. For example, driver training circuit 210 may retrieve one or more performance criteria assigned to the vehicular maneuver from vehicular maneuver information 236. Driver training circuit 210 may then compare the vehicle states (or operating conditions) to the one or more performance criteria to confirm the vehicular maneuver was successfully performed.

Based on the determination, one or more attribute levels of the driver-training feedback are adjusted at operation 425. For example, responsive to a determination at operation 420 that the vehicular maneuver was successfully executed, one or more attribute levels are decreased. Whereas, responsive to a determination at operation 420 that the vehicular maneuver was not successfully executed, one or more attribute levels are increased. Examples of methodologies for the increase and decrease are provided above in connection with FIGS. 3A and 3B. The adjusted attribute level may be stored in the training program information 234 for use during the next iteration of performing the maneuver.

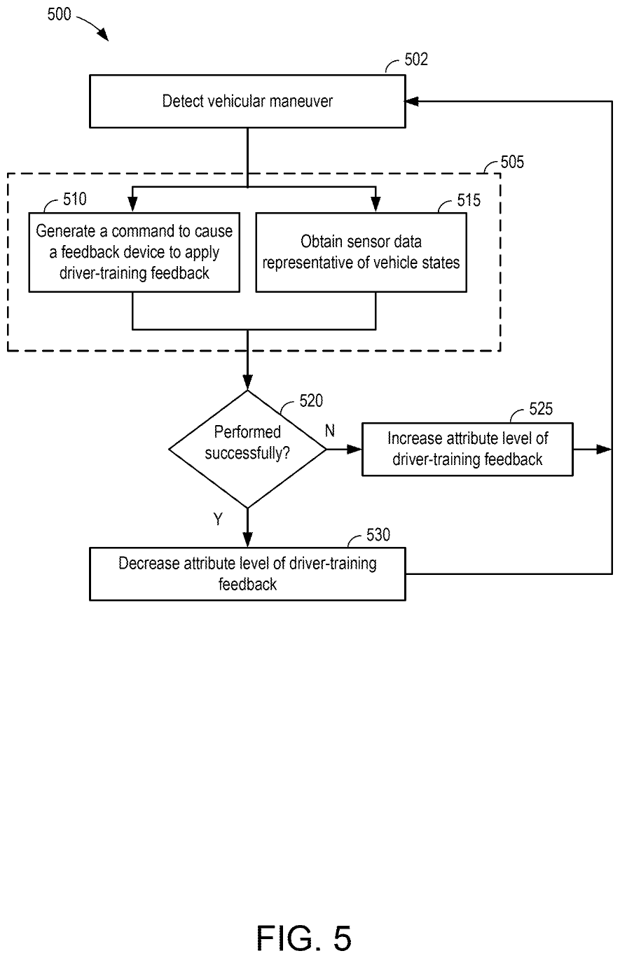

FIG. 5 is a flow chart illustrating another example of operations for adaptive driver training process 500 in accordance with an embodiment disclosed herein. Process 500 may be implemented as instructions, for example, stored on driver training circuit 210, that when executed by one or more processors perform one or more operations of process 500. In another example, process 500 may be implemented as instructions stored on cloud servers 292 that, when executed by one or more processors, perform one or more operations of process 500.

At operation 502, a vehicular maneuver is detected, for example, by driver training circuit 210. As described above, driver training circuit 210 may obtain sensor data from sensors 252 and vehicle systems 258 from which vehicle states and/or operating conditions can be derived. The vehicle states and/or operating conditions can be compared to performance criteria in vehicular maneuver information 236 to identify a vehicular maneuver that is being performed. That is, vehicle states and/or operating conditions may correspond to performing a vehicular maneuver by a vehicle, which can be used to identify the vehicular maneuver by referencing vehicular maneuver information 236.

Once a vehicular maneuver is detected, while performing the vehicular maneuver 505, driver-training feedback can be generated at operation 510, and sensor data obtained representative of vehicle states and/or operating conditions of the vehicle while executing the maneuver at operation 515. Operations 510 and 515 may be substantively similar to operation 410 and operation 415, respectively.

At operation 520, a determination is made as to whether or not the vehicular maneuver was successfully performed. The determination may be similar to the determination made at operation 420 described above. Responsive to a determination at operation 520 that the vehicular maneuver was successfully executed, one or more attribute levels are decreased at operation 530. Whereas, responsive to a determination at operation 520 that the vehicular maneuver was not successfully executed, one or more attribute levels are increased at operation 525.

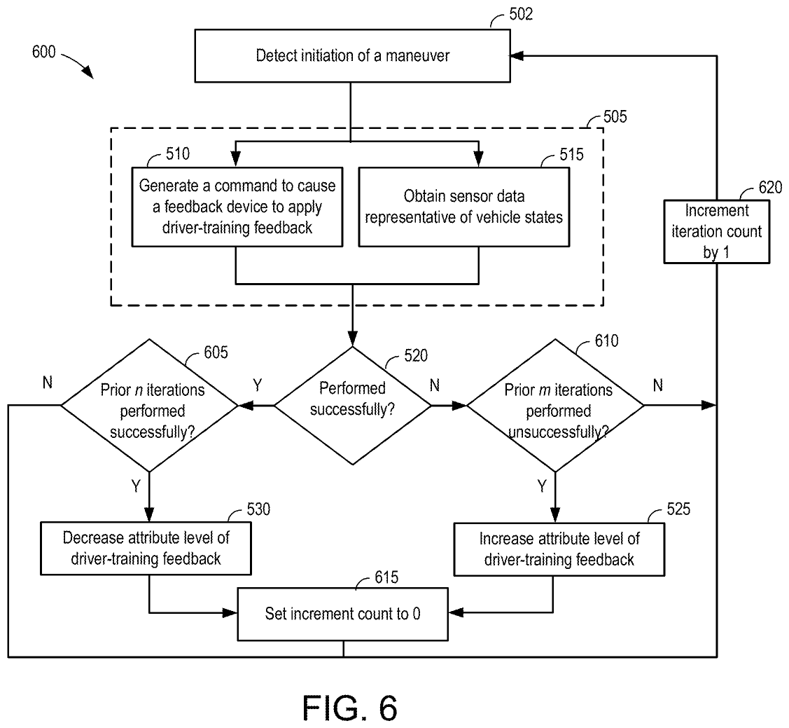

FIG. 6 is a flow chart illustrating another example of operations for adaptive driver training process 600 in accordance with an embodiment disclosed herein. Process 600 may be implemented as instructions, for example, stored on driver training circuit 210, that when executed by one or more processors perform one or more operations of process 600. In another example, process 600 may be implemented as instructions stored on cloud servers 292, that when executed by one or more processors to perform one or more operations of process 600.

Process 600 may be substantively similar to process 500, except as provided herein. For example, process 600 includes operations 502-520, 525, and 530 of process 500. Process 600 adds the n-up, m-down rule described above in connection with FIGS. 3A and 3B. Thus, upon a determination of a successful maneuver at operation 520, process 600 proceeds to operation 605 where process 600 checks if the prior n iterations of the maneuver were performed successfully. If so, process 600 proceeds to operation 530. Otherwise, process 600 continues without adjusting an attribute level. Whereas, if a determination at operation 520 is that the maneuver was unsuccessful, process 600 proceeds to operation 610 to check if the prior m iterations were unsuccessful. If so, process 600 proceeds to operation 525. Otherwise, process 600 continues without adjusting an attribute level. After adjusting the attribute level at either operation 530 or operation 520, process 600 proceeds to operation 615 where the increment count is reset to zero, and then increments the iteration count by one at operation 620. Whereas, if the determinations at operation 605 or operation 610 are negative (e.g., unsuccessful), process 600 proceeds to operation 620 where the increment count is increased by one and the process is repeated. The values for n and m may be set in advance as desired for each training session. Furthermore, at the start of a training session or upon a first detection at 502, the increment count may be set to one.

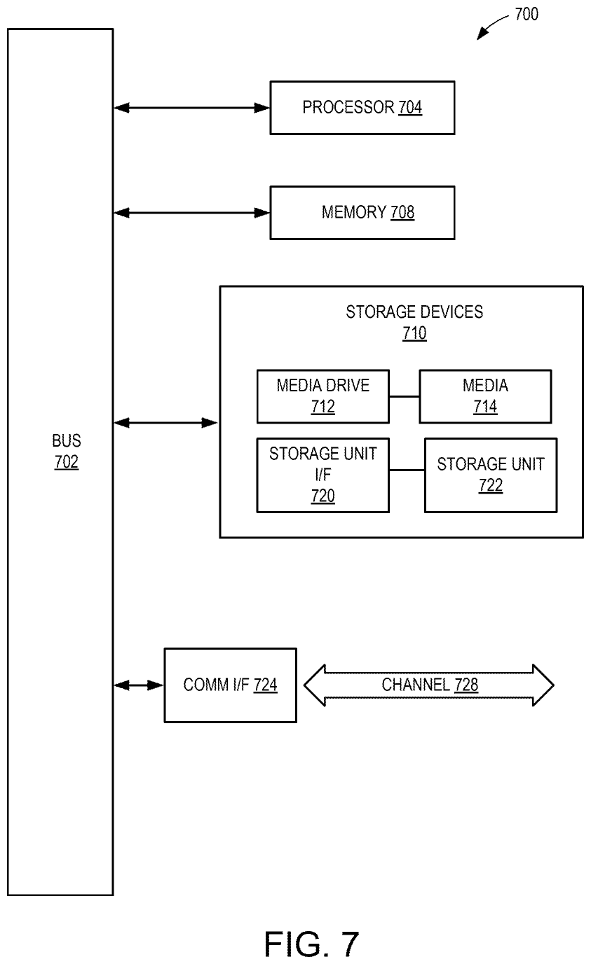

### FIG. 7

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 7. Various embodiments are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability.

Computing component 700 might include, for example, one or more processors, controllers, control components, or other processing devices. This can include a processor, and/or any one or more of the components making up driver training system 200 of FIG. 2. Processor 704 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. Memory 708 may store instructions that when executed by processor 704 cause computing component 700 to perform the operations of process 400, process 500, and/or process 600. Main memory 708 might also be used for storing temporary variables or other intermediate information during execution of instructions to be executed by processor 704. Computing component 700 might likewise include a read only memory (“ROM”) or other static storage device coupled to bus 702 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing component 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for adaptive driver-training feedback, the method comprising:
generating a command signal to cause a feedback circuit to apply driver-training feedback to a driver of a vehicle, wherein the driver-training feedback is applied to induce successful performance of a maneuver;
iteratively obtaining, from one or more sensors on a vehicle, sensor data corresponding to vehicle states of the vehicle during iterative performance of the maneuver, the maneuver comprising one or more performance criteria indicative of successful performance of the maneuver; and
for each iteration of performing the maneuver:
determining whether the maneuver was successfully performed by the vehicle based on the sensor data obtained during the iteration and the performance criteria; and
adjusting a level of an attribute of the driver-training feedback responsive to the determination.

2. The method of claim 1, wherein the level of the attribute of the driver-training feedback comprises intensity.

3. The method of claim 1, wherein the level of the attribute of the driver-training feedback comprises frequency.

4. The method of claim 1, wherein the driver-training feedback comprises at least one of audio, visual and haptic feedback.

5. The method of claim 1, further comprising:
responsive to a determination that the maneuver was successfully performed by the vehicle, decreasing the level of the attribute of the driver-training feedback.

6. The method of claim 5, further comprising:
iteratively decreasing the level of the attribute of the driver-training feedback for each iteration of successful performance of the maneuver until the maneuver is not performed successfully.

7. The method of claim 1, further comprising:
responsive to a determination that the maneuver was not successfully performed by the vehicle, increasing the level of the attribute of the driver-training feedback.

8. The method of claim 7, further comprising:
iteratively increasing the level of the attribute of the driver-training feedback for each iteration in which the maneuver was not performed successfully until the maneuver is performed successfully.

9. The method of claim 1, further comprising:
maintaining the level of the attribute of the driver-training feedback for a plurality of sequential iterations of successful performance of the maneuver.

10. The method of claim 9, further comprising:
decreasing the level of the attribute of the driver-training feedback for a next iteration of successful performance of the maneuver that follows the plurality of sequential iterations.

11. A vehicle, comprising:
a feedback circuit;
one or more sensors; and
one or more processors communicably coupled to a memory and configured to execute instructions stored in the memory to:
generate a command signal to cause a feedback circuit to apply driver-training feedback to a driver of a vehicle, wherein the driver-training feedback is applied to induce successful performance of a maneuver;
iteratively obtain, from one or more sensors on a vehicle, sensor data corresponding to vehicle states of the vehicle during iterative performance of the maneuver, the maneuver comprising one or more performance criteria indicative of successful performance of the maneuver; and
for each iteration of performing the maneuver:
determine whether the maneuver was successfully performed by the vehicle based on the sensor data obtained during the iteration and the performance criteria; and
adjust a level of an attribute of the driver-training feedback responsive to the determination.

12. The vehicle of claim 11, wherein the level of the attribute of the driver-training feedback comprises at least one of intensity and frequency.

13. The vehicle of claim 11, wherein the driver-training feedback comprises at least one of audio, visual and haptic feedback.

14. The vehicle of claim 11, wherein the one or more processors are further configured to execute the instructions to:
responsive to a determination that the maneuver was successfully performed by the vehicle, decrease the level of the attribute of the driver-training feedback.

15. The vehicle of claim 14, wherein the one or more processors are further configured to execute the instructions to:
iteratively increase the level of the attribute of the driver-training feedback for each iteration in which the maneuver was not performed successfully until the maneuver is performed successfully.

16. The vehicle of claim 11, wherein the one or more processors are further configured to execute the instructions to:
responsive to a determination that the maneuver was not successfully performed by the vehicle, increase the level of the attribute of the driver-training feedback.

17. The vehicle of claim 16, wherein the one or more processors are further configured to execute the instructions to:
iteratively increase the level of the attribute of the driver-training feedback for each iteration in which the maneuver was not performed successfully until the maneuver is performed successfully.

18. A driver training system, the driver training system comprising:
a communication interface configured to receive sensor data from sensors on a vehicle, the sensor data indicative of operation conditions of the vehicle executing a vehicular maneuver; and
a driver training circuit configured to adjust an attribute of driver-training feedback based on a comparison of the operating conditions to a set of performance criteria associated with the vehicular maneuver, wherein the set of performance criteria are representative of a successful execution of the vehicular maneuver.

19. The driver training system of claim 18, wherein the driver training circuit is further configured to:
generate a command signal to cause a feedback circuit to apply driver-training feedback to a driver of a vehicle according to the adjusted attribute of the driver-training feedback.

20. The driver training system of claim 18, wherein the driver training circuit is further configured to:
determine whether the vehicular maneuver was successfully performed by the vehicle based on the sensor data and the performance criteria;
based on a determination that the vehicular maneuver was successfully performed by the vehicle, decreasing the level of the attribute of the driver-training feedback; and
based on a determination that the vehicle maneuver was not successfully performed by the vehicle, increasing the level of the attribute of the driver-training feedback.
